(19) United States
(12) Patent Application Publication
(10) Pub. No.: US 2015/0101559 A1
(43) Pub. Date: Apr. 16, 2015

(54) BUTTON FOR ROCKER ARM ASSEMBLY

(71) Applicant: Caterpillar Inc., Peoria, IL (US)

(72) Inventors: Paul D. Rudolph, Lafayette, IN (US); Andrew J. Menssen, Bloomington, IL (US)

(73) Assignee: Caterpillar Inc., Peoria, IL (US)

(21) Appl. No.: 14/053,778

(22) Filed: Oct. 15, 2013

(51) Int. Cl. F01L 1/46; F02M 63/00; F01L 1/18

(52) U.S. Cl. CPC F01L 1/46; F01L 1/18; F02M 63/001
USPC 123/188.4; 74/102

(57) ABSTRACT

The present disclosure provides a button for a rocker arm assembly. The button includes a head portion. The button includes a shank extending from the head portion along a longitudinal axis. The button further includes a base portion extending from the shank. The base portion has a bottom surface, wherein the bottom surface has a substantially concave profile.

### TECHNICAL FIELD

Present disclosure relates to a rocker arm assembly for an engine and more particularly to a button for the rocker arm assembly.

### BACKGROUND

Conventionally, the engine includes a rocker arm assembly operatively coupled to a camshaft. The rocker arm assembly includes an insert received within a rocker arm such that a valve or injector tappet and the insert/button are operatively coupled. The valve tappet and the insert/button experience a frictional force during successive events of valve operation. The frictional force builds up stress around the valve tappet, and results in wear of the insert and the valve or injector tappet. Moreover, the friction between the injector tappet and the insert/button leads to deformation of various other components associated with an injector or the valve system.

US published application number 2008257293 discloses a connection device for connecting rocker, valve or injection assemblies in internal combustion engines, including a button defining a recess for housing herein an insert coupled to a rocker assembly or the like, the recess including a lubricating hole and the button comprising a button face contacting a driving plate and including a slot extending radially between the lubricating hole and the outer periphery of the button.

### SUMMARY

In one aspect, the present disclosure provides a button for a rocker arm assembly. The button includes a head portion. The button includes a shank extending from the head portion along a longitudinal axis. The button further includes a base portion extending from the shank. The base portion has a bottom surface, wherein the bottom surface has a substantially concave profile.

In one aspect, the present disclosure provides a rocker arm assembly includes a rocker arm forming an insert bore. The rocker arm assembly includes an insert disposed within the insert bore. The rocker arm assembly further includes a button attached to the insert. The button includes a head portion. The button includes a shank extending from the head portion along a longitudinal axis. The button further includes a base portion extending from the shank. The base portion has a bottom surface, wherein the bottom surface has a substantially concave profile.

In another aspect, the present disclosure provides an injector train for an engine. The injector train includes at least one fuel injection valve operative between an open position and a closed position. The injector train further includes a rocker arm operatively coupled to the fuel injection valve. The rocker arm includes an insert and a button. The button includes a head portion. The button includes a shank extending from the head portion along a longitudinal axis. The button further includes a base portion extending from the shank. The base portion has a bottom surface, wherein the bottom surface has a substantially concave profile.

Other features and aspects of this disclosure will be apparent from the following description and the accompanying drawings.

### BRIEF DESCRIPTION OF THE DRAWINGS

FIG. 1 illustrates a sectional view of an exemplary internal combustion engine;

FIG. 2 illustrates a fuel injection valve and a rocker arm assembly of FIG. 1;

FIG. 3 illustrates a front view of a button of FIG. 2;

FIG. 4 illustrates a detailed view of a first concave profile of a bottom surface of the button;

FIG. 5 illustrates a detailed view of a second concave profile of the bottom surface of the button; and

FIG. 6 illustrates a sectional view of an exemplary internal combustion engine according to another aspect of the present disclosure.

### DETAILED DESCRIPTION

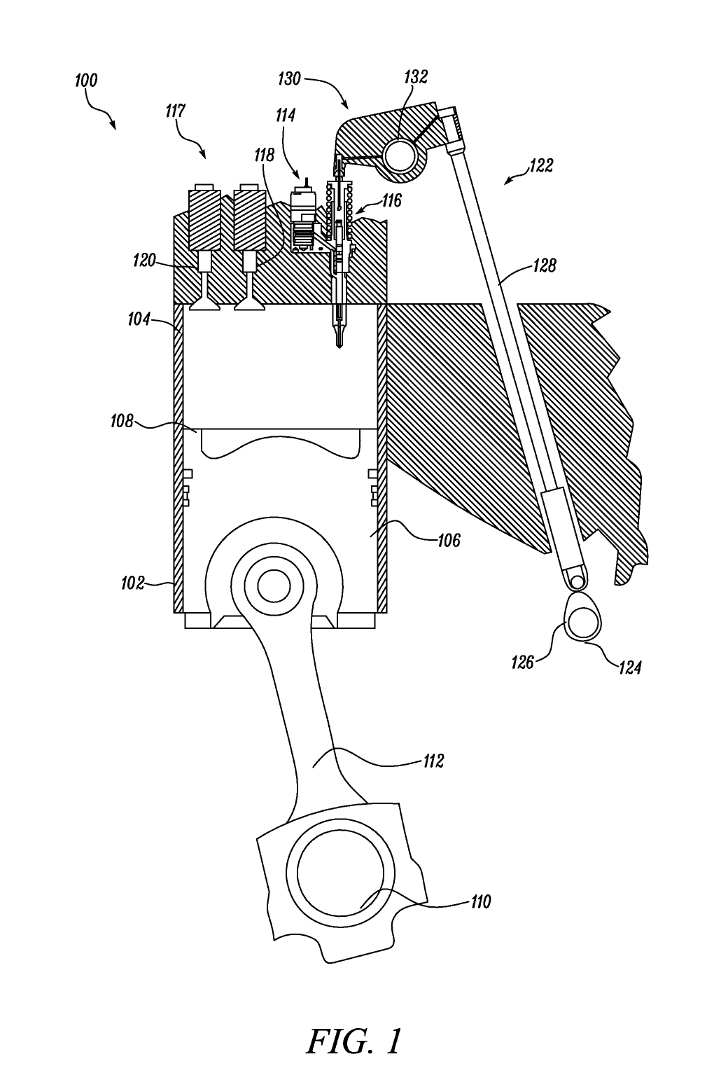

FIG. 1 illustrates a sectional view of an exemplary internal combustion engine 100, hereinafter referred to as the engine 100. The engine 100 may be any type of engine (internal combustion, gas, diesel, gaseous fuel, natural gas, or propane based engine etc.), may be of any size, with any number of cylinders, and in any configuration (“V,” in-line, radial, etc.). The engine 100 may be used to power any machine or other device, including on-highway trucks or vehicles, off-highway trucks or machines, earth moving equipment, generators, aerospace applications, locomotive applications, marine applications, pumps, stationary equipment, and other engine powered applications.

In an aspect of the present disclosure, the engine 100 may be a compression ignition internal combustion engine, such as a diesel engine. For clarity, the following description refers to a single cylinder engine 100, but the principle of the present disclosure can as easily be applied to a multi-cylinder engine. The engine 100 includes a cylinder block 102, and a cylinder head 104 attached to the cylinder block 102. In the exemplary embodiment shown in FIG. 1, the engine 100 may include a piston 106 configured to reciprocate within a cylinder 108 defined in the cylinder block 102. The piston 106 is connected to a crankshaft 110 via a connecting rod 112. The engine 100 may include an injector train 114 and a valve train 117. The injector train 114 may include a fuel injection valve 116 and the valve train 117 may include one or more valves such as, an intake valve 118 and an exhaust valve 120, disposed within the cylinder head 104. The fuel injection valve 116, the intake valve 118 and the exhaust valve 120 are operative between an open position and a closed position.

The injector train 114 further includes a valve actuation assembly 122. In an exemplary embodiment, the valve actuation assembly 122 includes a camshaft 124 having a lobe 126 to push against a pushrod 128 and configured to transfer the rotary motion of the camshaft 124 into a linear motion of at least one of the fuel injection valve 116, the intake valve 118 and the exhaust valve 120 via a rocker arm assembly 130. In the illustrated embodiment, the rocker arm assembly 130 is pivotally mounted on the cylinder head 104 about a pivot point 132 and engages the fuel injection valve 116. Moreover, other rocker arm assemblies, such as the rocker arm assembly 130, may also engage with the intake valve 118 and the exhaust valve 120. However, it will be apparent to a person having an ordinary skill in the art that other types of valve actuation assemblies such as an overhead-camshaft with a sliding inverted-follower, or an overhead-camshaft with pivoted-rocker assembly, fall within the scope of the present invention.

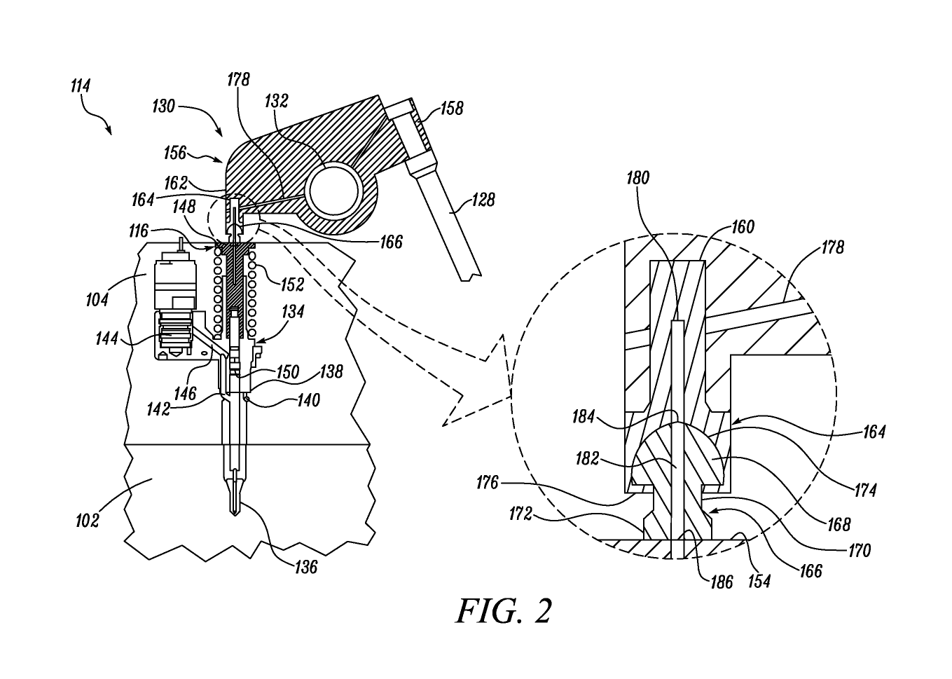

FIG. 2 illustrates the fuel injection valve 116 and the rocker arm assembly 130 of FIG. 1. The fuel injection valve 116 includes an injector body 134. One end of the injector body 134 defines a nozzle 136 adjacent to the cylinder 108. In an embodiment, an outer surface 138 of the injector body 134 includes one or more sealing means such as O-rings 140. The O-rings 140 are configured to seal the fuel injection valve 116 in the cylinder head 104 to prevent leakage of combustion gasses from inside the cylinder 108. The injector body 134 defines a fuel port 142 in fluid communication with a fuel valve 144 via a fuel channel 146. The fuel valve 144 is configured to supply a fuel to the fuel injection valve 116. In an exemplary embodiment as shown in FIG. 2, the fuel valve 144 may be a solenoid operated valve 144 electrically coupled to a controller such as an Engine Control Unit (ECU) associated with the engine 100. However, in alternative embodiments, the fuel valve 144 may be actuated and/or operated hydraulically, mechanically, electrically, piezo-electrically, or any combination thereof. The fuel injection valve 116 further includes a tappet 148, a plunger 150, and a biasing means, such as a spring 152 disposed within the injector body 134. The plunger 150 is movable within the injector body 134 based on an actuation from the tappet 148. During a fuel injection event, the plunger 150 underneath the tappet 148 pressurizes fuel received from the solenoid operated fuel valve 144 and pushes the fuel into the cylinder 108. The tappet 148 includes a tappet surface 154 operatively coupled to the rocker arm assembly 130. The spring 152 retracts the plunger 150 and the tappet 148 and maintains the tappet surface 154 in contact with the rocker arm assembly 130 throughout the operation of the injector train 114.

According to an aspect of the present disclosure, the rocker arm assembly 130 includes a rocker arm 156 pivotally attached to the pushrod 128 at a first end 158 of the rocker arm 156. The rocker arm 156 defines an insert bore 160 at a second end 162 to receive an insert 164 therein. In an aspect of the present disclosure, the rocker arm assembly 130 further includes a button 166 attached to the insert 164. The button 16 includes a head portion 168, a shank 170 extending from the head portion 168, and a base portion 172 extending from the shank 170.

As shown in a detailed view in FIG. 2, the insert 164 may include a recessed portion 174 having a profile conjugate to a profile of the head portion 168 of the button 166. In the illustrated embodiment, the recessed portion 174 may include a substantially hemispherical cavity and the head portion 168 may include a substantially hemispherical profile to be received in the recessed portion 174. The recessed portion 174 may further include a flange 176 extending inwardly such that the head portion 168 of the button 166 rests against the flange 176. However, in various other embodiments, the insert 164 may define a substantially hemispherical profile and the head portion 168 may define a substantially hemispherical cavity to receive the insert 164 therein. Alternatively, the head portion 168 may define a rectangular profile and the recessed portion 174 may define a rectangular cavity to receive the head portion 168 therein. Moreover, in alternative embodiments, the head portion 168 of the button 166 may include a threaded profile and the insert bore 160 may define a threaded receptacle such that the button 166 may be fastened to the threaded receptacle defined on the insert bore 160. By the foregoing discussion, a person having an ordinary skill in the art will appreciate that various geometrical profiles may be contemplated for the insert 164 and the head portion 168 to achieve the attachment of the head portion 168 to the insert 164. In an embodiment, the button 166 may be press-fitted inside the recessed portion 174. However, in other embodiments, the button 166 may be attached to the insert 164 using various other techniques like interference fitting, friction fitting and the like as commonly known in the art. In an embodiment as illustrated in FIG. 2, the base portion 172 of the button 166 is configured to abut the tappet surface 154.

In an exemplary embodiment, the engine 100 may include a lubrication system. The lubrication system is configured to provide a lubrication fluid to the fuel injection valve 116 via the rocker arm assembly 130. As illustrated in FIG. 2, the rocker arm assembly 130 is fluidly connected to the insert 164 via a fluid channel 178 disposed therein. The insert 164 defines a first fluid channel 180 configured to carry the lubrication fluid to the button 166.

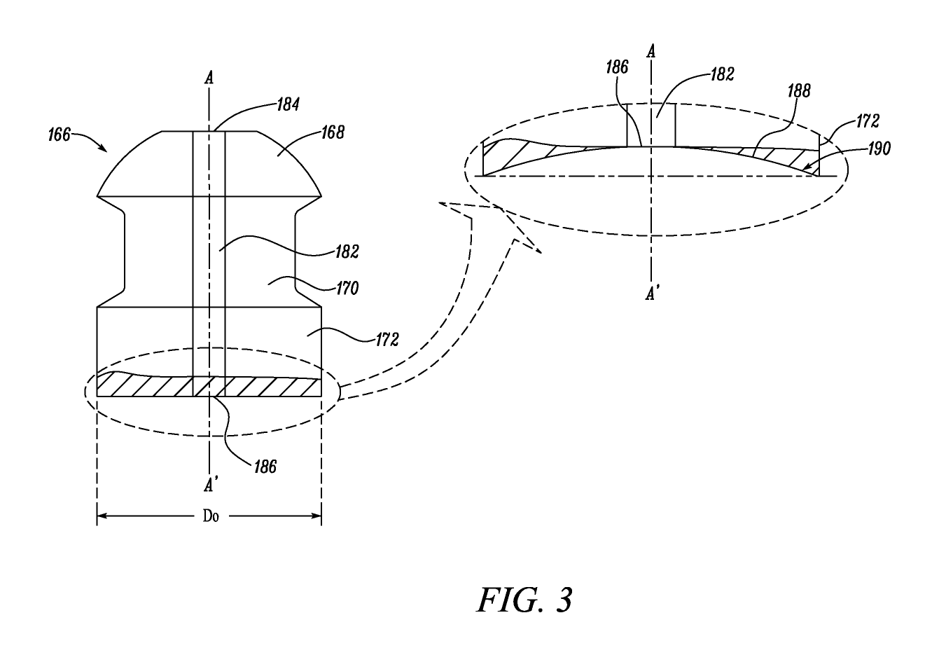

FIG. 3 illustrates a front view of the button 166 in an aspect of the present disclosure. As illustrated, the base portion 172 of the button 166 may have a substantially cylindrical profile extending along the longitudinal axis AA′ such that a second fluid channel 182 extends from the head portion 168 to the base portion 172 along the longitudinal axis AA′. The second fluid channel 182 has a first opening 184 on the head portion 168 defining an inlet for lubrication fluid and a second opening 186 on a bottom surface 188 of the base portion 172 defining an outlet for the lubrication fluid.

In an embodiment, an outer diameter (Do) of the base portion 172 may lie in a range of about 5 mm to 100 mm. However, in the embodiment illustrated, the outer diameter (Do) of the base portion 172 is in a range of 10 mm to 15 mm. As illustrated in a detailed view of FIG. 3, the bottom surface 188 defines a substantially concave profile 190 having a radius of curvature (Rc). In an embodiment, a ratio (Rc:Do) of the radius of curvature (Rc) of the concave profile 190 to the outer diameter (Do) of the base portion 172 lies in the range of about 1:1 to 200:1. However, in the embodiment illustrated herein, the ratio (Rc:Do) is about 30:1.

In an embodiment, the button 166 may be made of hardened steel. However, in alternative embodiments, one may choose other suitable wear resistant materials, which can sustain varying cycles of fatigue and temperatures to manufacture the button 166. In an embodiment, the button 166 may be manufactured by machining and/or grinding a steel stock. However, in other embodiments various other manufacturing techniques like forging or casting may be used to manufacture the button 166 of present disclosure.

### INDUSTRIAL APPLICABILITY

The industrial applicability of the button 166 for the rocker arm assembly 130 described herein will be readily appreciated from the foregoing discussion.

Typically Fuel injection valves used for diesel engines are mechanically actuated via a rocker arm assembly. The rocker arm assembly is configured to oscillate about the pivot point with each rotation of the camshaft and actuate a tappet associated with the fuel injector valve via a button associated with the rocker arm assembly. A person ordinarily skilled in the art will acknowledge that during successive injection events, the tappet and the button move relatively and experience a frictional force. This frictional force may lead to wearing of the button and the tappet. Moreover, due to a sliding motion between the button and the tappet, a high bending moment acts on the tappet. This high bending moment may lead to a wear of O-rings associated with sealing of an injector body to the engine and in extreme situations may fail the O-rings.

However, with the button 166 of the present disclosure, the concave profile 190 of the bottom surface 188 reduces the frictional force experienced on the tappet surface 154. In an embodiment, the tappet 148 may define a third fluid channel 192 such that the second fluid channel 182 of the button 166 is fluidly coupled to the tappet 148. The lubrication oil may travel through the third fluid channel 192 of the tappet 148 and lubricate the fuel injection valve 116. Thus, the O-rings 140 and the injector body 134 have an improved service life. Further, the concave profile 190 forms a lubrication volume 194 between the second opening 186 and the tappet surface 154. When the lubrication system provides the lubrication oil to the button 166, the lubrication oil may be trapped in the lubrication volume 194 to form an oil bubble to evenly lubricate the tappet surface 154.

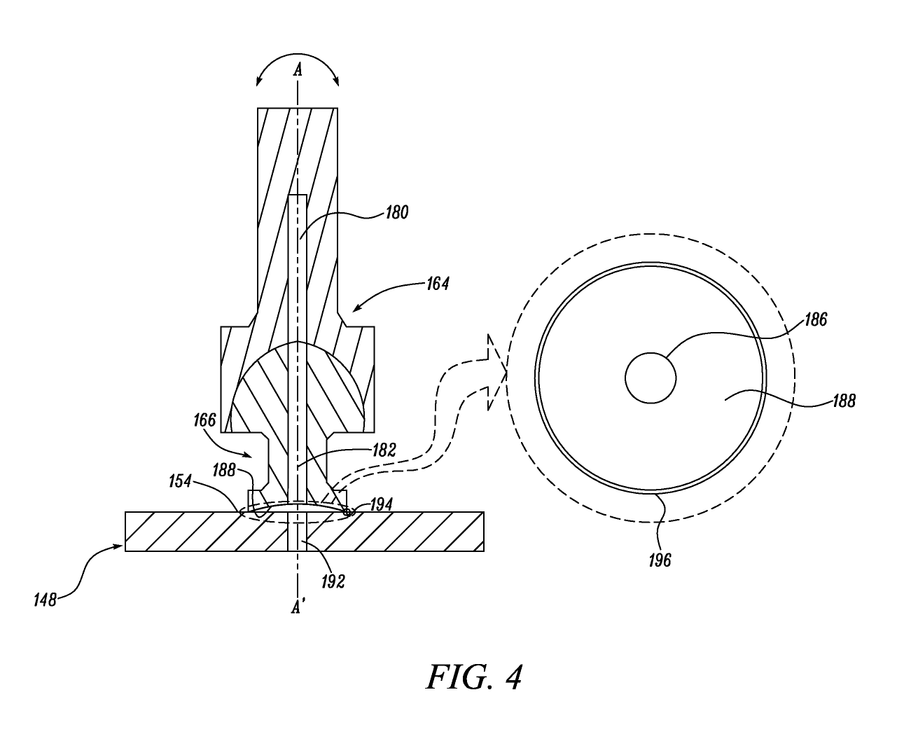

FIG. 4 illustrates a detailed view of a first concave profile 190 of the bottom surface 188 of the button 166 in contact with the tappet surface 154. The first concave profile 190 corresponds to the bottom surface's 188 profile of the button 166 which is newly manufactured. During an initial operation of the injector train 114, the first concave profile 190 defines a line contact such as a circle of contact 196 with the tappet surface 154. According to an aspect of the present disclosure, the first concave profile 190 may allow the lubrication oil to reach outermost edges 194 of the bottom surface 188 and lubricates the tappet surface 154.

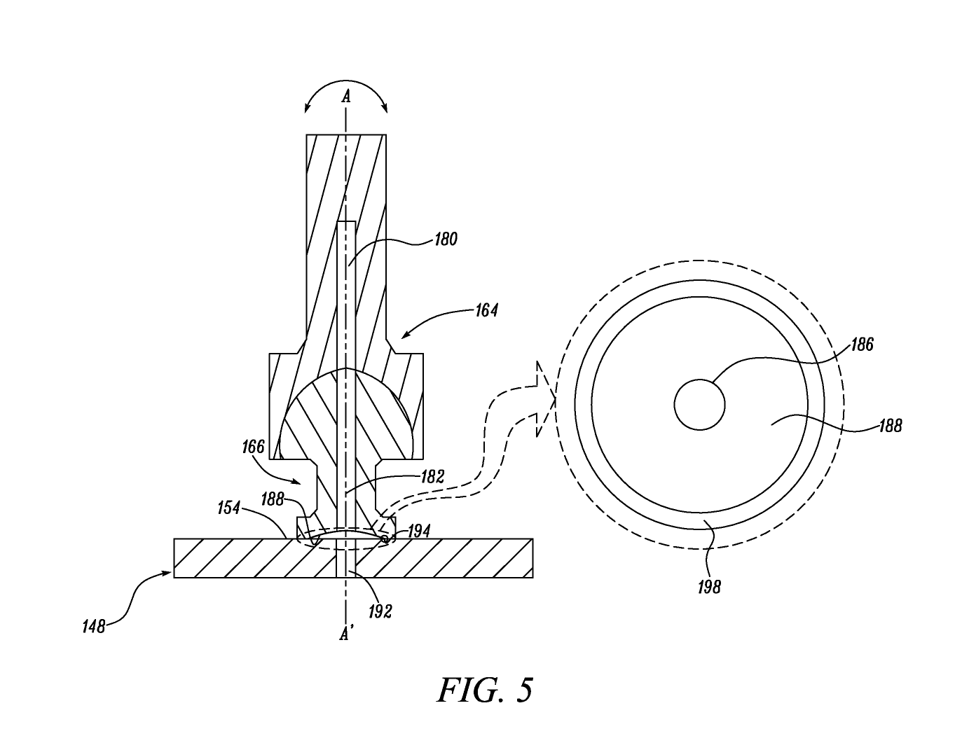

FIG. 5 illustrates a detailed view of a second concave profile 190 of the bottom surface 188 of the button 166 in contact with the tappet surface 154. The second concave profile 190 corresponds to the bottom surface's 188 profile of the button 166 which has undergone few cycles of operation of the injector train 114. During the operation of the injector train 114, the second concave profile 190 defines a surface contact such as an annulus of contact 200 with the tappet surface 154. As shown in a detailed view of FIG. 5, after successive injection events, the bottom surface 188 may wear such that outermost edges 196 become substantially flat to define the annulus of contact 200 with the tappet surface 154. It will be apparent to a person skilled in the art that the insert 164 provides a rocking motion to the button 166. The rocking motion allows the lubricating fluid to spread over the annulus of contact 200.

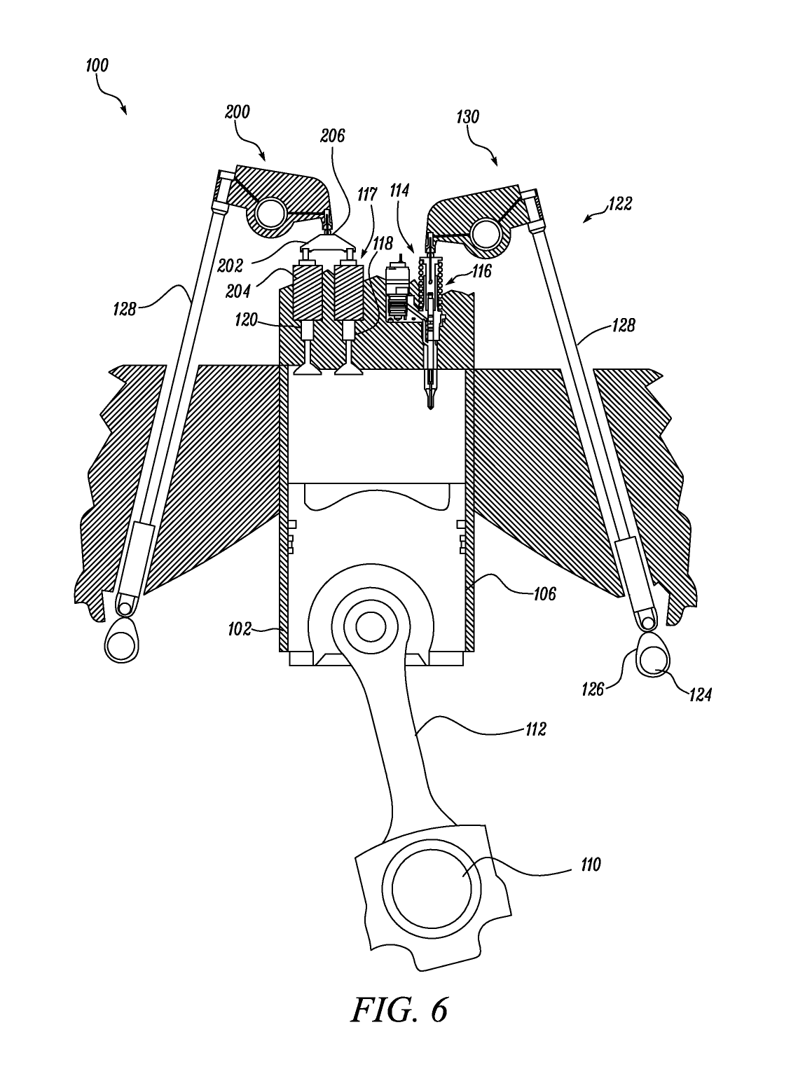

FIG. 6 illustrates the valve train 117 associated with the engine 100 of the present disclosure. As illustrated, the valve train 117 may include a rocker arm assembly 200 in engagement with the intake valve 118 and the exhaust valve 120 via a valve bridge 202. In an embodiment, the rocker arm assembly 200 is substantially similar to the rocker arm assembly 130 as described above. In an aspect of the present disclosure, the valve bridge 202 is a multi-valve actuating valve bridge. As will be appreciated by a person having ordinary skill in the art, the valve bridge 202 is shown to be associated with two valves 118, and 120, however, the valve bridge may be associated with any number of valves without deviating from the scope of the present disclosure. Furthermore, the valve bridge 202 may be connected to each of the valves 118, and 120 through a pair of valve stem 204. A valve spring 206 may be located around each valve stem 204 between the cylinder head 104 and the valve bridge 202. The valve spring 204 may be configured to bias the valves 118, and 120, into engagement with respective valve seats to close fuel intake and/or exhaust ports.

In an embodiment, the bridge rocker arm assembly 200 includes the button 166. The head portion 168 of the button 166 may be attached to the rocker arm 156 and the bottom surface 188 of the button 166 may be engaged with a central upstanding rocker arm engaging tappet head 206.

From the foregoing it will be appreciated that, although specific embodiments have been described herein for purposes of illustration, various modifications or variations may be made without deviating from the spirit or scope of inventive features claimed herein. Other embodiments will be apparent to those skilled in the art from consideration of the specification and figures and practice of the arrangements disclosed herein. It is intended that the specification and disclosed examples be considered as exemplary only, with a true inventive scope and spirit being indicated by the following claims and their equivalents.

What is claimed is:

1. A button for a rocker arm assembly, the button comprising:
a head portion;
a shank extending from the head portion along a longitudinal axis; and
a base portion extending from the shank, the base portion having a bottom surface, wherein the bottom surface has a substantially concave profile.

2. The button of claim 1, wherein an outer diameter of the base portion lies in the range of 5 mm to 100 mm.

3. The button of claim 1, wherein a ratio of a radius of curvature of the concave profile to the outer diameter of the base portion lies in a range of 1:1 to 200:1.

4. The button of claim 1, wherein a ratio of a radius of curvature of the concave profile to the outer diameter of the base portion is 30:1.

5. The button of claim 1 further comprising:
at least one fluid channel, wherein the at least one fluid channel extending from the head portion to the base portion substantially along the longitudinal axis of the button;
a first opening on a head surface; and
a second opening on the bottom surface.

6. The button of claim 1 is made of hardened steel.

7. A rocker arm assembly comprising:
a rocker arm forming an insert bore;
an insert disposed within the insert bore; and
a button attached to the insert, the button including:
a head portion;
a shank extending from the head portion along a longitudinal axis; and
a base portion extending from the shank, the base portion having a bottom surface, wherein the bottom surface has a substantially concave profile.

8. The rocker arm assembly of claim 7, wherein an outer diameter of the base portion of the button lies in the range of 5 mm to 100 mm.

9. The rocker arm assembly of claim 7, wherein a ratio of a radius of curvature of the concave profile to the outer diameter of the base portion lies in a range of 1:1 to 200:1.

10. The rocker arm assembly of claim 7, wherein a ratio of a radius of curvature of the concave profile to the outer diameter of the base portion is 30:1.

11. The rocker arm assembly of claim 7, wherein the button further comprising:
at least one fluid channel, wherein the at least one fluid channel extending from the head portion to the base portion along the longitudinal axis of the button;
a first opening on a head surface; and
a second opening on the bottom surface.

12. The rocker arm assembly of claim 7, wherein the button is made of hardened steel.

13. An injector train for an engine, the injector train comprising:
a fuel injection valve operative between an open position and a closed position;
a rocker arm operatively coupled to the fuel injection valve, the rocker arm including a insert; and
a button attached to the insert, the button including:
a head portion;
a shank extending from the head portion a longitudinal axis; and
a base portion extending from the shank, the base portion having a bottom surface, wherein the bottom surface has a substantially concave profile.

14. The injector train of claim 13, wherein an outer diameter of the base portion of the button lies in the range of 5 mm to 100 mm.

15. The injector train of claim 13, wherein a ratio of a radius of curvature of the concave profile to the outer diameter of the base portion lies in a range of 1:1 to 200:1.

16. The injector train of claim 13, wherein a ratio of a radius of curvature of the concave profile to the outer diameter of the base portion is 30:1.

17. The injector train of claim 13, wherein the button further comprising:
at least one fluid channel, wherein the at least one fluid channel extending from the head portion to the base portion along the longitudinal axis of the button;
a first opening on a head surface; and
a second opening on the bottom surface.

18. The injector train of claim 13, wherein the button is made of hardened steel.

19. The injector train of claim 13, wherein the rocker arm is operatively connected to a camshaft.

20. A valve train for an engine, the valve train comprising:
at least one valve operative between an open position and a closed position;
a rocker arm operatively coupled to the at least one valve via a valve bridge, the rocker arm including a insert; and
a button attached to the insert, the button including:
a head portion;
a shank extending from the head portion a longitudinal axis; and
a base portion extending from the shank, the base portion having a bottom surface, wherein the bottom surface has a substantially concave profile.
